(19) United States
(12) Patent Application Publication
(10) Pub. No.: US 2026/0222324 A1
(43) Pub. Date: Jul. 30, 2026

(54) SYSTEM AND METHOD FOR CORRELATING CUSTOMER SERVICE REQUESTS

(71) Applicant: JIO PLATFORMS LIMITED, Ahmedabad (IN)

(72) Inventors: Rahul JOSHI, Jaipur (IN); Ritesh BAVISI, Mumbai (IN); Gaurav AGARWAL, Thane (IN); Rajeev SALUJA, Gurgaon (IN); Raghuram VALEGA, Mumbai (IN)

(73) Assignee: JIO PLATFORMS LIMITED, Ahmedabad (IN)

(21) Appl. No.: 19/151,860

(22) PCT Filed: Jan. 30, 2024
(86) PCT No.: PCT/IB2024/050840

§ 371 Date: Jul. 29, 2025

(30) Foreign Application Priority Data
Jan. 30, 2023 (IN) 202321005963

(51) Int. Cl. H04L 41/5074; G06Q 10/0631; H04L 41/0631

(52) U.S. Cl. CPC H04L 41/5074; G06Q 10/06311; H04L 41/0631

(57) ABSTRACT

The present disclosure provides a system (108) and a method (800) for correlating customer service requests. The method (800) includes receiving (802) one or more customer service requests from one or more sources, and determining (804) one or more attributes and one or more parameters of each customer service request. Further, the method (800) includes determining (806) an occurrence of one or more issues based on the one or more parameters and the one or more attributes, and determining (808) one or more network resources associated with the occurrence of the one or more issues.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for mobile network complaint management systems. More particularly, the present disclosure relates to a system and a method for correlating customer service requests (SR) that is automatic, efficient, and promotes business growth.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Mobile network complaint management systems facilitate real-time customer interaction and address multiple issues related to network efficiency. Effective complaint systems are used to provide customer assistance in various organizations. Digital evolution has enabled customers to communicate their complaints through multiple modes such as contact centre, chats, e-mail, social media, etc. Query request complaints (QRCs) require an intervention of a backend team and are termed as Service Request(s) (SR). Based on the combination of type, sub type, sub-sub type, and latitude/longitude, the complaint is assigned to a respective resolver group by a service manager. The resolver group may analyse the complaint and provide resolution remarks through the service manager. However, network analytics generated by the service manager are not shown to the resolver group which leads to a delay in customer assistance. Hence, an effective solution management system is required to process the customer complaint systems.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method that manages customer Query, Resolution, and Complaints (QRC) through highly efficient automated services.

It is an object of the present disclosure to provide a system and a method that receives QRC and generates Root Cause Analytics (RCA) related to different issues and possible solutions corresponding to each issue.

It is an object of the present disclosure to provide a system and a method that addresses critical issues associated with the complaint management system and provides an effective solution.

It is an object of the present disclosure to provide a system and a method that improves the efficiency of network operations team through an automated and accurate diagnosis.

It is an object of the present disclosure to provide a system and a method that generates Service Request (SR) details and RCA together to provide a customized automated solution to customers.

It is an object of the present disclosure to provide a system and a method that customizes a business solution and provides customer satisfaction by addressing poor services and facilitates resolver groups for solutions.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for correlating customer service requests. The system includes one or more processors and a memory operatively coupled to the one or more processors, where the memory includes processor-executable instructions, which on execution, cause the one or more processors to receive one or more customer service requests from one or more sources, and determine one or more attributes and one or more parameters of each of the one or more customer service requests. Further, the one or more processors determine an occurrence of one or more issues based on the one or more parameters and the one or more attributes, and determine one or more network resources associated with the occurrence of the one or more issues.

In an embodiment, the one or more parameters may include at least one of: a measurement of Radio Frequency (RF) transaction data, coverage data, number of the one or more customer service requests received within a predetermined time period, complaint history, customer experiences within a predefined time period corresponding to a sector, status of port out alarm request, distance between the one or more network resources and a customer, Channel Quality Indicator (CQI), utilization of resources, and location of the customer.

In an embodiment, the customer experience within the predefined time period may include at least one of: a poor voice duration, a poor High-Speed Synchronous Interface (HSI) duration, and a poor coverage duration.

In an embodiment, the one or more attributes may include at least one of: a type of the one or more customer service requests, a sub-type of the one or more customer service requests, an identity of the one or more customer service requests, a customer identity, a creation time of the one or more customer service requests, a resolved time of the one or more customer service requests, a status of the one or more customer service requests, voice data of the one or more customer service requests, and assignment group of the one or more customer service requests.

In an embodiment, the one or more processors may scan a customer health card corresponding to each of the one or more customer service requests to extract the one or more parameters, and determine a root cause of each of the one or more issues based on the one or more parameters.

In an embodiment, the one or more processors may determine one or more resolutions with respect to each of the one or more issues occurred in each network resource, and generate one or more work orders corresponding to each of the one or more resolutions. Further, the one or more processors may determine one or more work groups corresponding to each of the one or more work orders, and assign each of the one or more work orders to the one or more work groups.

In another aspect, the present disclosure relates to a method for correlating customer service requests. The method includes receiving, by one or more processors associated with a system, one or more customer service requests from one or more sources, and determining, by the one or more processors, one or more attributes and one or more parameters of each of the one or more customer service requests. Further, the method includes determining, by the one or more processors, an occurrence of one or more issues based on the one or more parameters and the one or more attributes, and determining, by the one or more processors, one or more network resources associated with the occurrence of the one or more issues.

In an embodiment, the method may include scanning, by the one or more processors, a customer health card corresponding to each of the one or more customer service requests to extract the one or more parameters, and determining, by the one or more processors, a root cause of each of the one or more issues based on the one or more parameters.

In an embodiment, the method may include determining, by the one or more processors, one or more resolutions with respect to each of the one or more issues occurred in each network resource, and generating, by the one or more processors, one or more work orders corresponding to each of the one or more resolutions. Further, the method may include determining, by the one or more processors, one or more work groups corresponding to each of the one or more work orders, and assigning, by the one or more processors, each of the one or more work orders to the one or more work groups.

In yet another aspect, the present disclosure relates to a non-transitory computer-readable medium comprising processor-executable instructions that cause a processor to receive one or more customer service requests from one or more sources and determine one or more attributes and one or more parameters of each customer service request. Further, the processor may determine an occurrence of one or more issues based on the one or more parameters and the one or more attributes and determine one or more network resources associated with the occurrence of the one or more issues.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) of a system (108), in accordance with embodiments of the present disclosure.

FIG. 2 illustrates an exemplary block diagram (200) of the system (108) for correlating customer Service Request(s) (SR), in accordance with embodiments of the present disclosure.

FIG. 3 illustrates a schematic representation (300) of a high-level architecture of the system (108), in accordance with embodiments of the present disclosure.

FIG. 4 illustrates a schematic representation (400) of a high-level process of the system (108), in accordance with embodiments of the present disclosure.

FIG. 5 illustrates a schematic representation (500) of data flow of Root Cause Analytics (RCA), in accordance with embodiments of the present disclosure.

FIG. 6 illustrates a schematic representation (600) of fixing a root cause, in accordance with embodiments of the present disclosure.

FIG. 7 illustrates a schematic representation (700) of providing SR resolutions through system of interaction, in accordance with embodiments of the present disclosure.

FIG. 8 illustrates an example flow chart of a method (800) for correlating the customer SR, in accordance with embodiments of the present disclosure.

FIG. 9 illustrates an exemplary computer system (900) in which or with which the system (108) may be implemented, in accordance with embodiments of the present disclosure.

The foregoing shall be more apparent from the following more detailed description of the disclosure.

### BRIEF DESCRIPTION OF THE INVENTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

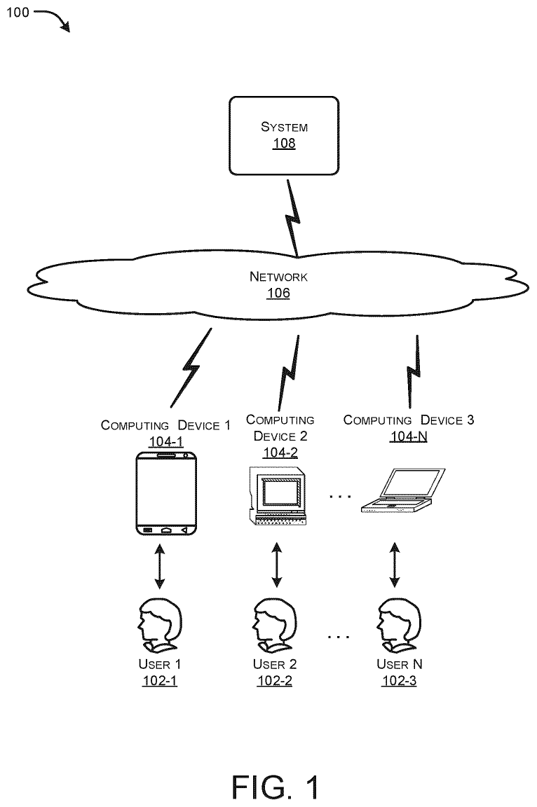

The various embodiments throughout the disclosure will be explained in more detail with reference to FIGS. 1-9.

FIG. 1 illustrates an exemplary network architecture (100) of a system (108), in accordance with embodiments of the present disclosure. As illustrated in FIG. 1, one or more computing devices (104-1, 104-2 . . . 104-N) may be connected to the system (108) through a network (106). A person of ordinary skill in the art will understand that the one or more computing devices (104-1, 104-2 . . . 104-N) may be collectively referred as the computing devices (104) and individually referred as the computing device (104). It should be understood that the computing device (104) may also be known as a user equipment (UE) that may include, but not be limited to, a mobile, a laptop, etc. Further, the computing devices (104) may include one or more in-built or externally coupled accessories including, but not limited to, a visual aid device such as a camera, audio aid, microphone, or keyboard. Further, the computing devices (104) may include a smartphone, virtual reality (VR) devices, augmented reality (AR) devices, a general-purpose computer, a desktop, a personal digital assistant, a tablet computer, and a mainframe computer. Additionally, input devices for receiving input from a user such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

Referring to FIG. 1, one or more users (102-1, 102-2 . . . 102-N) may be associated with the computing devices (104). A person of ordinary skill in the art will understand that the one or more users (102-1, 102-2 . . . 102-N) may be collectively referred as the users (102) and individually referred as the user (102). In an exemplary embodiment, the users (102) may be customers providing complaints and queries to the system (108) through the computing devices (104).

In an embodiment, the system (108) may be configured to generate Root Cause Analytics (RCA) based on inputs provided by a service manager (not shown in FIG. 1). In an embodiment, the service manager may record customer complaints and queries in the form of Service Request(s) (SR). In an embodiment, the service manager may receive the complaints and queries from the users (102) of the computing devices (104) through the network (106). In an embodiment, the service manager may be communicatively coupled with the system (108). Alternatively, or additionally, the service manager may be hosted within the system (108).

In an embodiment, the system (108) may be configured with a Data Platform (DP) (not shown in FIG. 1) that receives the SR from the service manager and generates RCA tables based on the inputs provided by the service manager. In an embodiment, the DP may provide solutions based on network resource level issues. Alternatively, or additionally, the DP may be hosted within the system (108).

In an embodiment, the SR may include, but not be limited to, service request number, open time, status, location, assignment group, sub type, sub-sub type, and the like.

In an embodiment, the RCA tables may include, but not be limited to, voice, High-speed Synchronous Interface (HSI), and coverage with various kinds of data.

In an exemplary embodiment, data in the RCA tables may include user (102) own voice complaints data for, for example, last 30 days and any mobile number portability requests generated by the user (102). Further, the data may include Radio Frequency (RF) transactions data, traces including measurement reports received from individual users (102) and their computing devices (104) for the last few days, for example, last 3 days. Furthermore, the data may include configuration data of the user (102) such as latitude, longitude, and the maximum impacting site and sectors, but not limited to the like. Additionally, the data may include maximum impacting site and sectors with information related to an individual Customer Health Card (CHC).

In an embodiment, the users (102) may raise Query, Resolution, and Complaints (QRCs) through multiple channels. Multiple channels may include voice of the customer (VoC) channels such as interactive voice response (IVR) and call centres. Further, multiple channels may include no voice of the customer (NVoC) channels such as e-mail, social media, chats, and the like.

In an embodiment, QRCs may be resolved by frontline agents tagged as On-Call Resolution (OCR). Further, QRCs may require intervention from a backend team and may be collectively termed as a SR. Based on the combination of type, sub type, sub-sub type, latitude, longitude, and the like, the complaint may be assigned to a resolver group by a service manager. Data from the service manager may be sent to the DP for further analysis through an SR correlation engine. In an embodiment, the SR correlation engine may be hosted within the system (108). The analysed data may then be provided to the users (102) through the DP.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

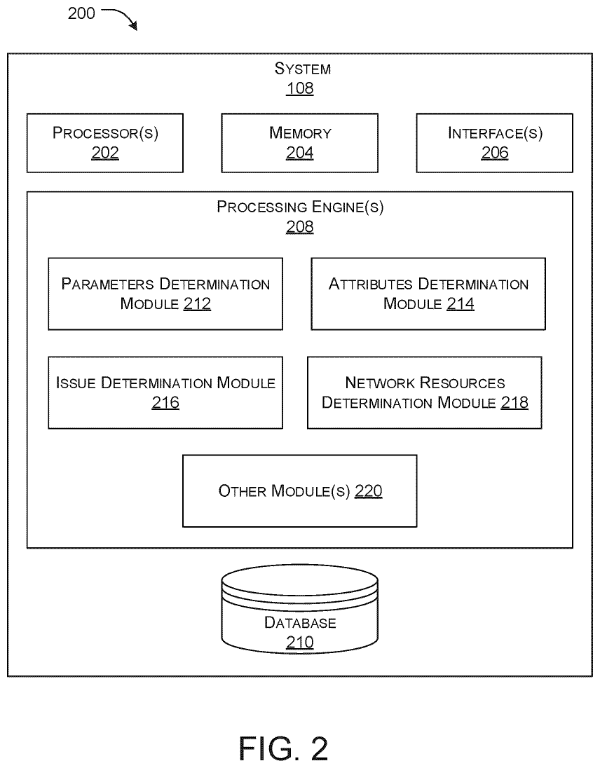

FIG. 2 illustrates an exemplary block diagram (200) of the system (108) for correlating customer SR, in accordance with embodiments of the present disclosure. A person of ordinary skill in the art will understand that the system (108) of FIG. 2 may be similar to the system (108) of FIG. 1 in functionality.

Referring to FIG. 2, the system (108) may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to correlate the SR. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output (I/O) devices, storage devices, and the like. The interface(s) (206) may facilitate communication through the system (108). The interface(s) (206) may also provide a communication pathway for one or more components of the system (108). Examples of such components include, but are not limited to, processing engine(s) (208) and a database (210).

The processing engine(s) (208) (e.g., SR correlation engine) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry. Further, the processing engine (208) may include a parameters determination module (212), an attributes determination module (214), an issue determination module (216), a network resources determination module (218), and other module(s) 220. The other module(s) (220) may implement functionalities that supplement applications/functions performed by the processing engine(s) 208.

When the system (108) receives customer SR from various sources such as, but not limited to, e-mails, chats, social media, Interactive Voice Response (IVR), call centre, and the like, the parameters determination module (212) may scan a customer health card corresponding to the customer SR to extract parameters of the customer SR. The attributes determination module (214) may determine attributes of the customer SR. In an embodiment, the parameters may include, but not limited to, a measurement of Radio Frequency (RF) transaction data, coverage data, number of SR received within a predetermined time period, complaint history, customer experiences within a predefined time period corresponding to a sector, status of port out alarm request, a distance between one or more network resources and the customer, a Channel Quality Indicator (CQI), utilization of resources, a location of the customer, and the like. In an exemplary embodiment, the customer experiences may be extracted for past 30 days, past 1 week, and similar durations after the reception of the SR. In an embodiment, the customer experiences within the predefined time period may Include, but not limited to, a poor voice duration, a poor HSI duration, a poor coverage duration, and the like. In an embodiment, the attributes may include, but not limited to, a type of service request, a sub-type of service request, identity of service request, customer identity, creation time of the service request, resolved time of the service request, status of service request, voice data of service request, assignment group of service request, and the like.

In some embodiments, once the parameters and the attributes are determined, the issue determination module (216) may determine an occurrence of issues and a root cause of the issues based on the parameters. In an embodiment, once the root cause of the issue is determined, the network resources determination module (218) may determine the network resources that are associated with the occurrence of the issues. In some embodiments, once the network resources are determined, the system (108) may determine resolutions with respect to the issues occurred in the network resources and generate work orders corresponding to the resolutions. Further, the system (108) may determine work groups corresponding to work orders and assign the work orders to the work groups. In some embodiments, the issues may be resolved based on two methods such as on-site resolutions and remote resolutions. For on-site resolutions, a manual intervention may be needed to resolve the issues by visiting on-site. For remote resolutions, the issues may be resolved by transmitting resolution commands to the appropriate network resources or nodes without the need for on-site presence.

In an embodiment, the system (108) may automate the procedures for resolution of customer SR and provide immediate and precise action to the field team for resolution. Further, the system (108) may correlate the SR with a network entity that caused impact to the customer, that is the system (108) may initiate RCA using various data streams and suggest root cause fix (RCF) that is resolution to empower the last mile engineer with actionable plan. Further, the system (108) may improve efficiency of the field network team and reduces resolution time for SRs.

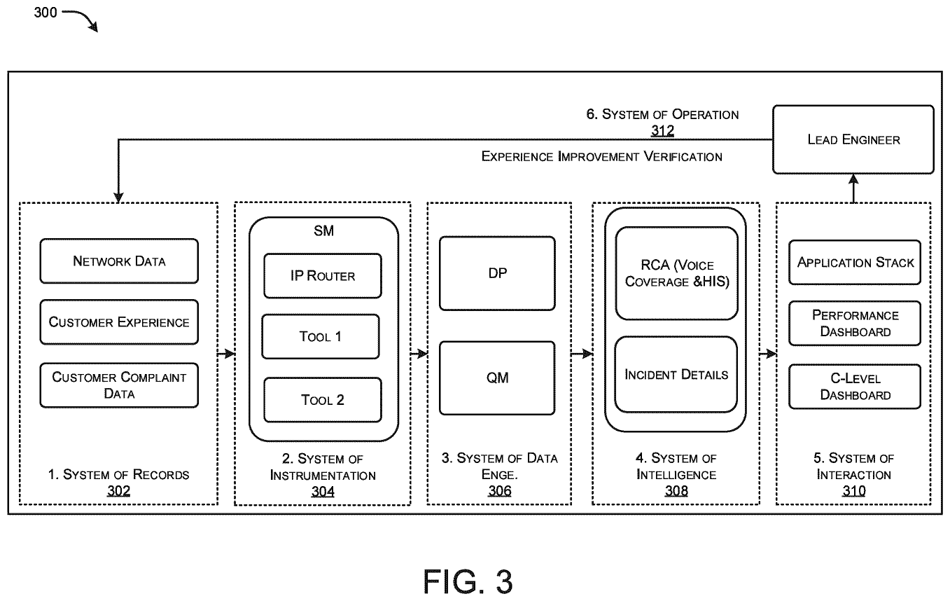

FIG. 3 illustrates a schematic representation (300) of a high-level architecture of a system (108), in accordance with embodiments of the present disclosure.

As illustrated in FIG. 3, the high-level architecture (300) may include multiple modules for processing the Query, Resolution, and Complaints (QRC) provided by users such as the users (102) of FIG. 1. The system (108) may be configured with a system of records module (302). The system of records module (302) may include network data, customer experience data, and customer complaint data, but not limited to the like. In an embodiment, network data may include information received from a Broadband Transmit Group (BTG). Further, a system of instrumentation module (304) may be configured in the system (108). The system of instrumentation module (304) may include the Service Manager (SM). The service manager may handle internet protocol (IP) router, and multiple tools (Tool 1, Tool 2) as shown in FIG. 3. Further, the SM may include service requests/requests (SR) from the users (102). The SR may include service request number, open time, status, location, assignment group, sub type, sub-sub type, and the like. The system (108) may be configured with a system of data engineering module (306) that may include a Data Platform (DP) and a Query Manager (QM). In an embodiment, the DP may refer to a Big Data Lake. The DP and the QM may process the information received from the system of records module (302) and the system of instrumentation module (306), and direct the information to a system of intelligence module (308) configured in the system (108).

The system of intelligence module (308) may include the SR correlation engine (e.g., 208). The system of intelligence module (308) may further generate RCA and incident details based on the information received from the system of data engineering module (306). The system of intelligence module (308) may also include different action groups based on problem domain and geography. The RCA analytics may include RCA tables with the following kinds of data such as Total customer complaints from last 30 days may be calculated and a port-out request alarm may be checked, bad duration may be calculated for last 3 days and maximum duration site and sectors may also be identified, various other data like customer's distance from the service cell, geo_latlong, city, a portout status (unique porting code status) may also be included for RCA analysis.

Additionally, the incident details may include incident details such as registration of open time and resolved time based on the SR. Based on the open time, the ageing/mean time to resolve (MTTR) may also be calculated. Further the incident details may include keywords, sub type, and sub-sub type. Information pertaining to the resolver group working on SR may also be specified.

In an embodiment, resolver groups may be action groups based on problem domain and geography. Furthermore, the RCA and incident details may be directed towards a system of interaction module (310) once they are processed by resolver groups. The system of interaction module (310) may include a C-level dashboard, a performance dashboard, and an application stack. Information generated by the system of interaction module (310) may be accessed by a lead engineer through a system of operation module (312). The lead engineer may further provide feedback to the system of records module (302) related to experience improvement verification associated with the processing of QRC.

In an embodiment, the system (e.g., 108) may identify and fix issues related to customer experience. The system (108) may improve the time taken to resolve customer complaints. Further, the system (108) may improve the network availability to multiple customers/users (102) using the same site.

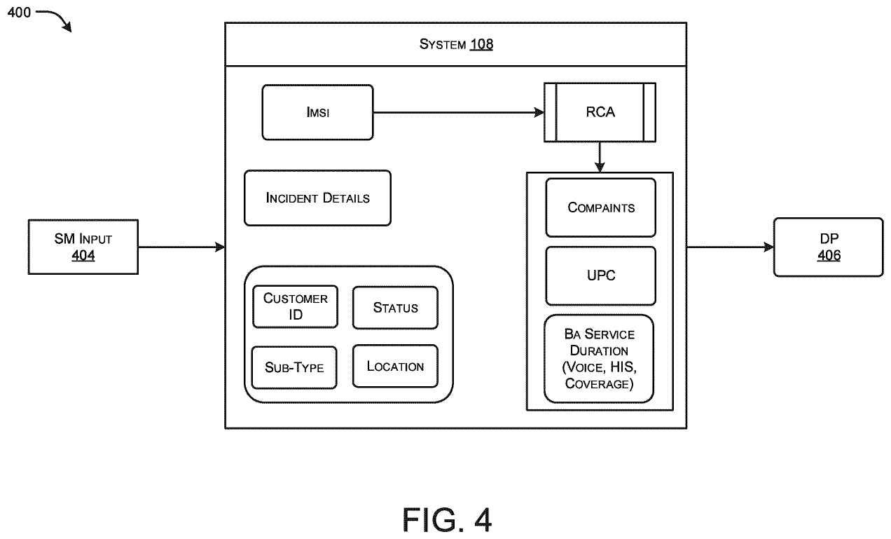

FIG. 4 illustrates a schematic representation (400) of a high-level process of a system (e.g., 108), in accordance with embodiments of the present disclosure.

As illustrated in FIG. 4, the system (108) may receive inputs from a Service Manager (SM) (404). The inputs provided by the SM (404) may include, but not be limited to, service request number, open time, status, location, assignment group, sub type, sub-sub type, and the like. Further, the system (108) may be configured with an International Module Subscriber Identity (IMSI) associated with a global system for mobile communication (GSM). The IMSI may identify the GSM network operator associated with a user. Further, the system (108) may utilize the IMSI, the incident details associated with a SR, and the inputs provided by the SM (404) to generate RCA tables as described earlier in FIG. 3. In an embodiments, RCA tables may include data related to, but not limited to customer complaints, bad service duration, and data related to customer complaints, bad service duration, port out status, and the like. Further, the output from the system (108) may be sent to the DP (406).

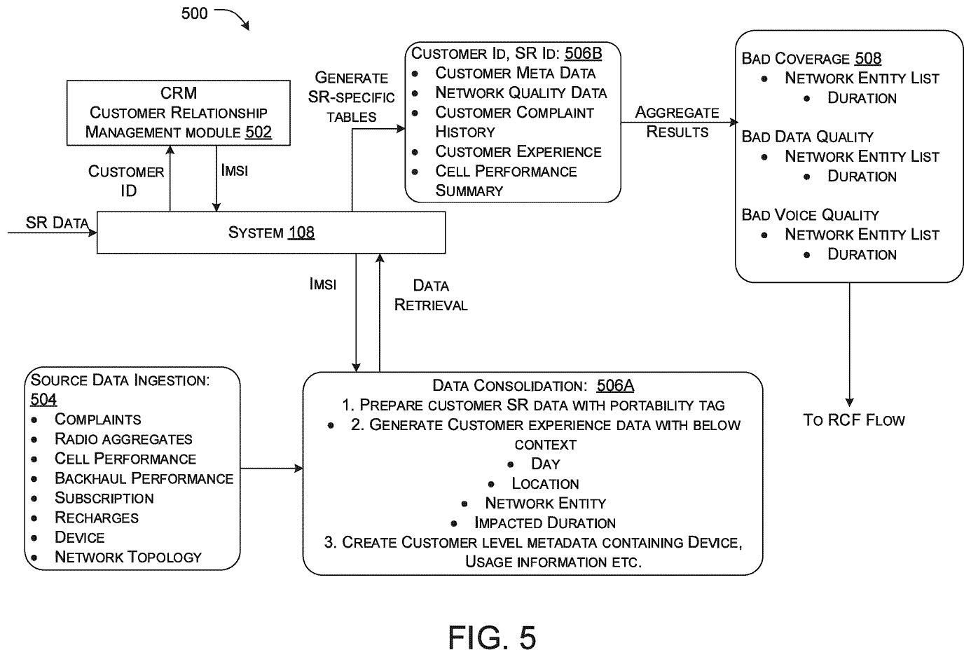

FIG. 5 illustrates a schematic representation (500) of data flow of RCA, in accordance with embodiments of the present disclosure.

In some exemplary embodiments, referring to FIG. 5, once a system (e.g., 108) receives customer SR, the system (108) may transmit a customer identity to the Customer Relationship Management (CRM) module (502). The CRM module (502) may transmit an IMSI to the system (108). Further, the system (108) perform data consolidation using IMSI as represented in block 506A. In some embodiments, the data consolidation process may include preparing customer SR data with portability tag and generating customer experience data with respect to day, location, network entity, impacted duration and the like. Further, the data consolidation process may include creating customer level metadata containing device, usage information and the like. In exemplary embodiment, during the data consolidation process, the system (108) may consider a source data ingestion as represented in block 504. The source data ingestion may include, but not limited to complaints, radio aggregators, cell performance, backhaul performance, subscription, rechargers, device information, network topology, and the like.

In an embodiment, once the system (108) performs the data consolidation process, the system 108 may retrieve the data for generating SR-specific tables with respect to customer Identity, and SR identity as represented in block 506B to generate aggregate results. In some exemplary embodiments, the customer identity and SR identity may include, but not limited to customer metadata, network quality data, customer complaint, history, customer experience, cell performance, and the like. In some embodiments, the aggregate results may be used to determine a bad coverage, a bad data quality, and a bad voice quality along with network entity list and duration. Based on this information, the system (108) may perform RCF flow.

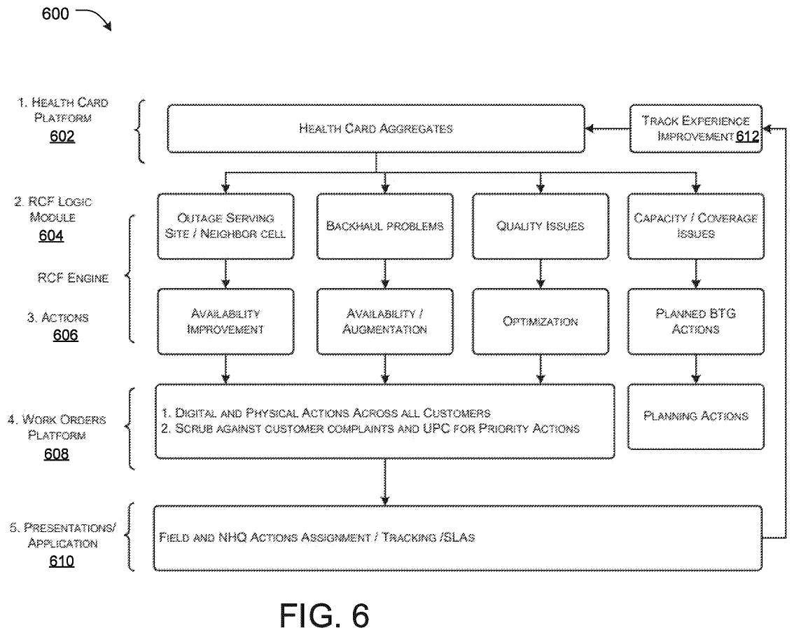

FIG. 6 illustrates a schematic representation (600) of fixing a root cause, in accordance with embodiments of the present disclosure.

In exemplary embodiments, referring to FIG. 6, at step (602), the Customer Health Card (CHC) module/engine may generate and aggregate the CHC details and saves the details in Big Data Lake (BDL). For example, all customer events (e.g., customer experiences) for last 30 days that capture coverage, data speed, cell quality index, consumption, voice, location, and availability details are aggregated. The generated CHCs and the aggregated data are stored in the BDL.

At steps (604) and (606) may be executed by a Root-Cause-Fix (RCF) engine/module that includes executing algorithms to access the BDL and analyse the issues related to outage service site/neighbour cell, backhaul problems, quality issues, capacity/coverage issues. Further, the RCF engine/module may perform actions for the identified/analysed issues, for example, availability improvement actions, availability/augmentation actions, optimization actions, planned BTG actions, etc. The RCF analysis is performed on every cell impacting customer experience as per the data aggregated at step (602) to identify digital and physical actions.

At step (608), a work order engine/module may analyse the digital and physical actions to be executed across all customers/sites. Further, the work order engine may scrub all actions against customer complaints and port out request data for priority actions. In an embodiment, the actions to be executed may be presented or published as a work order by the work order engine. The work order engine may be configured to facilitate the planning of actions based on capacity/coverage issues and planned BTG actions.

At step (610), a presentation module/engine (or the User Interface Application/Module) may publish or present field and NHQ action assignments, tracking information, and SLAs. In an embodiment, all work orders and actions through the work engine/module, are extracted and provided to field organization leadership through a presentation module/engine which leads to effective governance on the field.

At step (612), a tracking module/engine is configured to track the experience improvement of the customer based on insights about the corrective actions or resolution implemented and the newly acquired customer health card data from the BDL. In an embodiment, the tracking module/engine implements a closed loop feedback between the outcomes of the actions performed or executed to resolve the issues identified earlier and the improvement in the same issues post the execution of corrective actions.

In some embodiments, the system (108) may collect the customer events for 30 days, where the customer events may include coverage, a High-Speed Internet (HIS), a Channel Quality Indicator (CQI), consumption (e.g., resource utilization), voice quality, customer location and compilation of data related to the availability of services during this period. In an embodiment, the system (108) may perform RCF on every cell impacting customer experience, to identify remote resolutions and on-site resolutions. In some embodiments, the system (108) may scrub all actions against customer complaints (e.g., SR) and port out request data for priority actions and the system (108) may perform all actions through work order engine as represented in step (610). In exemplary embodiments, once the action sheet with a plan are prepared for field engineers, the digital workflow seamlessly integrates with specific systems for corresponding activities and provides input for action to either the field teams or the head office.

In some exemplary embodiments, after creating a SR ticket, the system (108) may utilize assigned ticket identity in the work order generation system to retrieve the network identity of the affected customer, enabling access to the Big Data Lake. This access may extract information related to customer complaints, network experience, and performance data, including complaint history, duration of subpar coverage or voice quality, distance from the service cell, radio frequency transaction data, and measurement reports from network entities serving the customer. Aggregated data from these sources are then input into the RCA function, generating an RCA table that identifies network entities responsible for issues such as poor voice quality, HSI problems, and coverage issues. Subsequently, utilizing the SR ticket identity allows deducing the root cause.

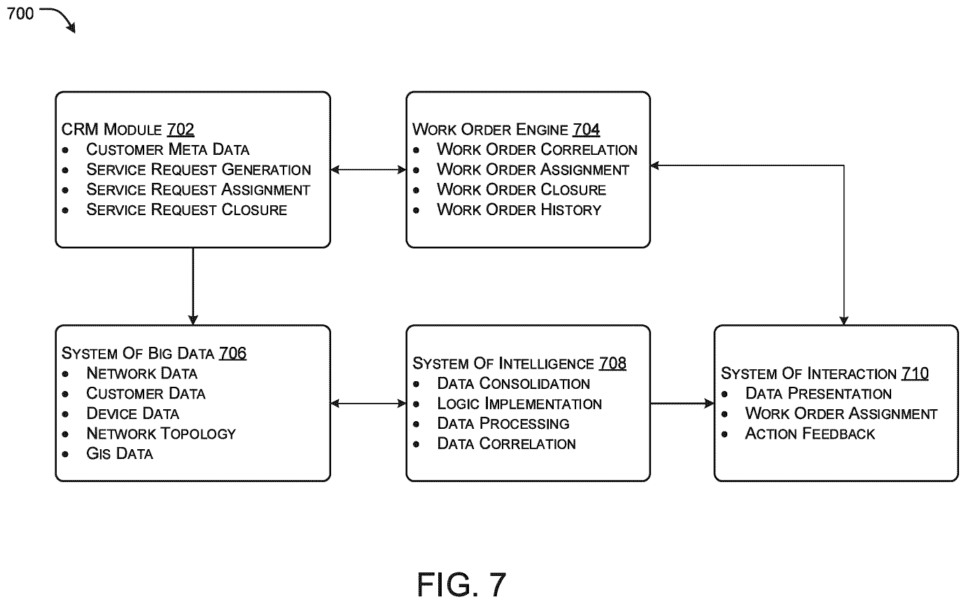

FIG. 7 illustrates a schematic representation (700) of providing SR resolutions through system of interaction, in accordance with embodiments of the present disclosure.

In some exemplary embodiments, referring to FIG. 7, at block (704), a system (e.g., 108) may include a work order engine to receive input from a CRM module as represented in block (702), where the input may include information of a customer metadata, SR generation, SR assignment, and SR closure. For example, the work order engine (704) may receive the input related to a service request, generates a work order, and assigns the work order to the relevant group. In an embodiment, the work order engine (704) may include information of work order correlation, work order assignment, work order closure, and work order history.

In an embodiment, at block (706), a system of big data may include information of network data, customer data, device data, network topology, and Geographical Information System (GIS) data. These information may be extracted based on the information received from the CRM module. At block (708), a system of intelligence may perform certain operations such as data consolidation, logic implementation, data processing, and data correlation. In some embodiments, at block (708, 710), the system (108) may aggregate the CRM input, RCA and RCF to present the aggregated information to a system of interaction, where the system of interaction (710) may perform certain operations such as data presentation, work order assignment, and providing feedback for actions (e.g., resolutions). In an embodiment, the field engineer may access the assigned SR, along with the RCA, on the unified system of interaction, retrieve the resolution steps through the RCF data, and promptly close the SR within the same system upon applying the RCF.

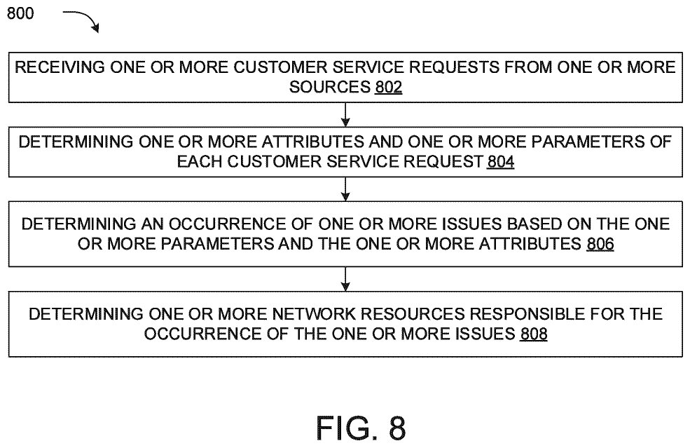

FIG. 8 illustrates an example flow chart of a method (800) for correlating the customer SR, in accordance with embodiments of the present disclosure.

Referring to FIG. 8, at block (802), the method (800) may include receiving one or more customer service requests from one or more sources. At block (804), the method (800) may include determining one or more attributes and one or more parameters of each customer service request. At block (806), the method (800) may include determining an occurrence of one or more issues based on the one or more parameters and the one or more attributes. Further, the method (800) may include scanning a customer health card corresponding to said each customer service request to extract the one or more parameters and determining a root cause of each issue based on the one or more parameters. At block (808), the method (800) may include determining one or more network resources associated with the occurrence of the one or more issues. Further, the method (800) may include determining one or more resolutions with respect to said each issue occurred in each network resource and generating one or more work orders corresponding to each resolution. Further, the method (800) may include determining one or more work groups corresponding to each work order and assigning said each work order to each work group.

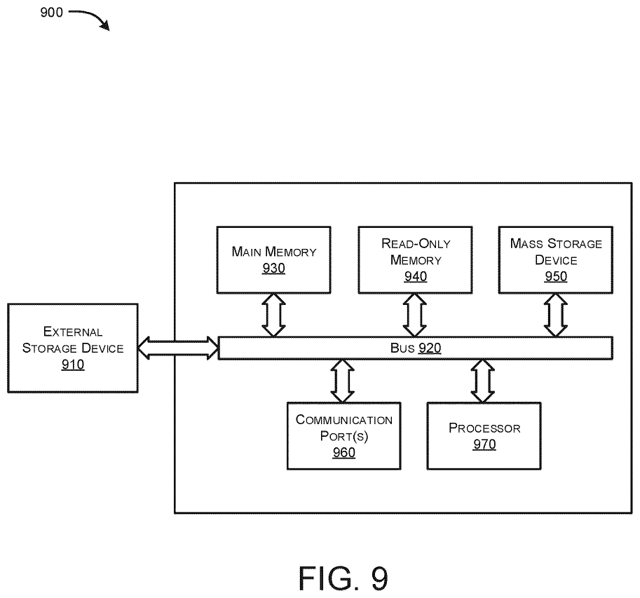

FIG. 9 illustrates an exemplary computer system (900) in which or with which the system (108) may be implemented, in accordance with embodiments of the present disclosure.

As shown in FIG. 9, the computer system (900) may include an external storage device (910), a bus (920), a main memory (930), a read-only memory (940), a mass storage device (950), a communication port(s) (960), and a processor (970). A person skilled in the art will appreciate that the computer system (900) may include more than one processor and communication ports. The processor (970) may include various modules associated with embodiments of the present disclosure. The communication port(s) (960) may be any of an RS-232 port for use with a modem-based dialup connection, a 10/100 Ethernet port, a Gigabit or 10 Gigabit port using copper or fibre, a serial port, a parallel port, or other existing or future ports. The communication port(s) (960) may be chosen depending on a network, such as a Local Area Network (LAN), Wide Area Network (WAN), or any network to which the computer system (900) connects. The main memory (930) may be Random Access Memory (RAM), or any other dynamic storage device commonly known in the art. The read-only memory (940) may be any static storage device(s) e.g., but not limited to, a Programmable Read Only Memory (PROM) chip for storing static information e.g., start-up or basic input/output system (BIOS) instructions for the processor (970). The mass storage device (950) may be any current or future mass storage solution, which can be used to store information and/or instructions.

The bus (920) may communicatively couple the processor (970) with the other memory, storage, and communication blocks. Optionally, operator and administrative interfaces, e.g., a display, keyboard, and cursor control device may also be coupled to the bus (920) to support direct operator interaction with the computer system (900). Other operator and administrative interfaces can be provided through network connections connected through the communication port(s) (960). In no way should the aforementioned exemplary computer system (900) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present disclosure provides a system and a method that manages customer Query, Resolution, and Complaints (QRC) through highly efficient automated services.

The present disclosure provides a system and a method that receives QRC and generates Root Cause Analytics (RCA) related to different issues and their possible solutions.

The present disclosure provides a system and a method that addresses critical issues associated with the complaint management system and provides an effective solution.

The present disclosure provides a system and a method that improves the efficiency of the network operations team through an automated and accurate diagnosis.

The present disclosure provides a system and a method that generates SR details and RCA together to provide a customized automated solution to customers.

The present disclosure provides a system and a method that customizes a business solution and provides customer satisfaction by addressing poor services and facilitates resolver groups for solutions.

We claim:

1. A system (108) for correlating customer service requests, comprising:
one or more processors (202); and
a memory (204) operatively coupled to the one or more processors (202), wherein the memory (204) comprises processor-executable instructions, which on execution, cause the one or more processors (202) to:
receive one or more customer service requests from one or more sources;
determine one or more attributes and one or more parameters of each of the one or more customer service requests;
determine an occurrence of one or more issues based on the one or more parameters and the one or more attributes; and
determine one or more network resources associated with the occurrence of the one or more issues.

2. The system (108) as claimed in claim 1, wherein the one or more parameters comprise at least one of: a measurement of Radio Frequency (RF) transaction data, coverage data, number of the one or more customer service requests received within a predetermined time period, complaint history, customer experience within a predefined time period corresponding to a sector, status of port out alarm request, distance between the one or more network resources and a customer, Channel Quality Indicator (CQI), utilization of resources, and location of the customer.

3. The system (108) as claimed in claim 2, wherein the customer experience within the predefined time period comprises at least one of: a poor voice duration, a poor High-Speed Synchronous Interface (HSI) duration, and a poor coverage duration.

4. The system (108) as claimed in claim 1, wherein the one or more attributes comprise at least one of: a type of the one or more customer service requests, a sub-type of the one or more customer service requests, an identity of the one or more customer service requests, a customer identity, a creation time of the one or more customer service requests, a resolved time of the one or more customer service requests, a status of the one or more customer service requests, voice data of the one or more customer service requests, and an assignment group of the one or more customer service requests.

5. The system (108) as claimed in claim 4, wherein the one or more processors (202) are to:
scan a customer health card corresponding to each of the one or more customer service requests to extract the one or more parameters; and
determine a root cause of each of the one or more issues based on the one or more parameters.

6. The system (108) as claimed in claim 1, wherein the one or more processors (202) are to:
determine one or more resolutions with respect to each of the one or more issues occurred in each network resource;
generate one or more work orders corresponding to each of the one or more resolutions;
determine one or more work groups corresponding to each of the one or more work orders; and
assign each of the one or more work orders to the one or more work groups.

7. A method (800) for correlating customer service requests, comprising:
receiving (802), by one or more processors (202) associated with a system (108), one or more customer service requests from one or more sources;
determining (804), by the one or more processors (202), one or more attributes and one or more parameters of each of the one or more customer service requests;
determining (806), by the one or more processors (202), an occurrence of one or more issues based on the one or more parameters and the one or more attributes; and
determining (808), by the one or more processors (202), one or more network resources associated with the occurrence of the one or more issues.

8. The method (800) as claimed in claim 7, comprising:
scanning, by the one or more processors (202), a customer health card corresponding to each of the one or more customer service requests to extract the one or more parameters; and
determining, by the one or more processors (202), a root cause of each of the one or more issues based on the one or more parameters.

9. The method (800) as claimed in claim 7, comprising:
determining, by the one or more processors (202), one or more resolutions with respect to each of the one or more issues occurred in each network resource;
generating, by the one or more processors (202), one or more work orders corresponding to each of the one or more resolutions;
determining, by the one or more processors (202), one or more work groups corresponding to each of the one or more work orders; and
assigning, by the one or more processors (202), each of the one or more work orders to the one or more work groups.

10. A non-transitory computer-readable medium comprising processor-executable instructions that cause a processor to:
receive one or more customer service requests from one or more sources;
determine one or more attributes and one or more parameters of each of the one or more customer service requests;
determine an occurrence of one or more issues based on the one or more parameters and the one or more attributes; and
determine one or more network resources associated with the occurrence of the one or more issues.
